(19) United States
(12) Patent Application Publication
(10) Pub. No.: US 2002/0065062 A1
(43) Pub. Date: May 30, 2002

(54) AUTOMATIC GSM MOBILE POWER

(76) Inventor: CHRISTIAN LEVESQUE, FOUNTAIN VALLEY, CA (US)

Correspondence Address: TED R. RITTMASTER, FOLEY & LARDNER, 2029 CENTURY PARK EAST, SUITE 3500, LOS ANGELES, CA, 90067-3021, US

(21) Appl. No.: 09/161,611

(22) Filed: Sep. 25, 1998

(51) Int. Cl. H04B 1/16

(52) U.S. Cl. 455/343

(57) ABSTRACT

Embodiments of the instant invention are directed to a communications system that monitors the output power level of the communications unit and adjusts the output power level so as to conserve power and maximize the duration of time that any given power supply can operate the communications unit. Preferred embodiments of the communications system include a power monitoring system for monitoring remaining capacity of a power supply and modulating the output power level of an amplifier. The power monitoring system is disposed within the communications unit and comprises a sensor and a processor, wherein the sensor monitors the remaining capacity and the processor modulates the output power level.

### FIELD OF THE INVENTION

The present invention relates, generally, to communication systems and processes and, in particular embodiments, to such systems, processes and devices with improved power usage efficiency, for example, which increase the duration of the time that the communication systems are operable on a limited power supply.

### DESCRIPTION OF THE RELATED ART

Electronic communication has become a part of many aspects of personal, business, military and other activities and tasks. As the popularity of various electronic communication devices increases, for example, personal communication devices such as cellular telephones, personal pagers, or the like, the demand for smaller, lighter, more power-efficient electronics increases.

In many popular applications, communication systems include portable or remote units that, in some instances, operate on limited power supplies, such as battery packs or the like, and/or are designed to be portable and stowable. It is typically desirable to minimize size, weight and power consumption requirements of the portable or remote units in such communication systems. For example, cellular telephone systems include cellular telephone units which, typically, operate on limited battery power and which are often designed to be carried in a pocket, briefcase, purse or the like. Similarly, cordless telephone systems include cordless units which operate on a rechargeable battery and which are designed to be relatively light-weight and portable. Of course, other communication systems would also benefit by minimizing size, weight and power consumption requirements.

In current cellular telephone communication systems, the power level used for a given transmission is determined, in part, by the base station. The base station communicates with the transmitter and a maximum power level (or range of power levels) acceptable for transmission is determined, typically based on the distance of the transmitter from the base station, fading conditions and frequency re-use plans and other conditions. The transmitter can transmit at the maximum allowed power level or some operable power level less than the maximum allowed power level. Generally, the greater the rate of power usage, the more rapid the power supply depletes. Further, the depletion of the power supply versus time is nonlinear and sharply declines after the power supply has been depleted to a certain level. Thus, it is difficult for a user to monitor the duration of time that the power supply will operate the communication system as the amount of power required for a given transmission fluctuates depending upon the location of the system with respect to the base station. Thus, there is a need in the industry to monitor the power level and to maximize the duration of time that any given power supply is capable of operating a communications unit that requires a limited power supply.

### SUMMARY OF THE DISCLOSURE

Embodiments of the instant invention are directed to communications systems and components thereof that monitor the output level of a limited power supply and adjusts output transmission power to conserve power, supply power, for example, to maximize the duration of time that the power supply can operate the communications unit. Preferred embodiments of the communications system include a transmitting unit having a power supply coupled to provide power to a transmission amplifier. A monitoring system is coupled to monitor the output level of the power supply and control the output transmission power level of the amplifier dependent on the output level of the power supply.

In one preferred embodiment, the monitoring system is disposed within a portable or remote transmitting unit and comprises a sensor, a processor and a limited power supply. The sensor senses the output level (for example, the output voltage or current level) of the power supply and compares it with a threshold value. When the sensed level reaches or passes a threshold value, the sensor provides a signal for notifying the processor of that event. The processor is programmed to control the amplifier to reset the predetermined output power level such that the rate of diminution of the power supply is reduced, for example, to extend the duration of time the power supply can operate the communication unit.

The above and other advantages of embodiments of this invention will be apparent from the following more detailed description when taken in conjunction with the accompanying drawings. It is intended that the above advantages can be achieved separately by different aspects of the invention and that additional advantages of this invention will involve various combinations of the above independent advantages such that synergistic benefits may be obtained from combined techniques.

### BRIEF DESCRIPTION OF THE DRAWINGS

The detailed description of preferred embodiments of the invention will be made with reference to the accompanying drawings, wherein like numerals designate corresponding parts in the figures.

FIG. 1 is a block diagram representation of a system environment according to an example embodiment of the present invention.

FIG. 2 is a block diagram representation of the transmitter of FIG. 1 including the monitoring and modulating system.

FIG. 3 is a schematic of preferred embodiment of a method of operation of an embodiment of the instant invention.

### DETAILED DESCRIPTION OF PREFERRED EMBODIMENTS

Embodiments of the present invention relate, generally, to portable communication systems that utilize limited power supplies, wherein the level of the power supply is monitored such that modifications in the level of power output can be made based on the remaining capacity of the power supply. Power level monitoring systems and processes according to embodiments of the present invention may be employed in a variety of communications electronics, including wireless transmission systems as well as wired systems. Thus, embodiments of the invention described herein may involve various forms of communications systems. However, for purposes of simplifying the present disclosure, preferred embodiments of the present invention are described herein, in relation to personal wireless communications systems, including, but not limited to digital mobile telephones, digital cordless telephones, digital pagers, combinations thereof, and the like. Such personal communications systems typically include one or more portable or remotely located receiver and/or transmitter units. In most applications, it is desirable to minimize the power requirements to increase usage time between power recharges.

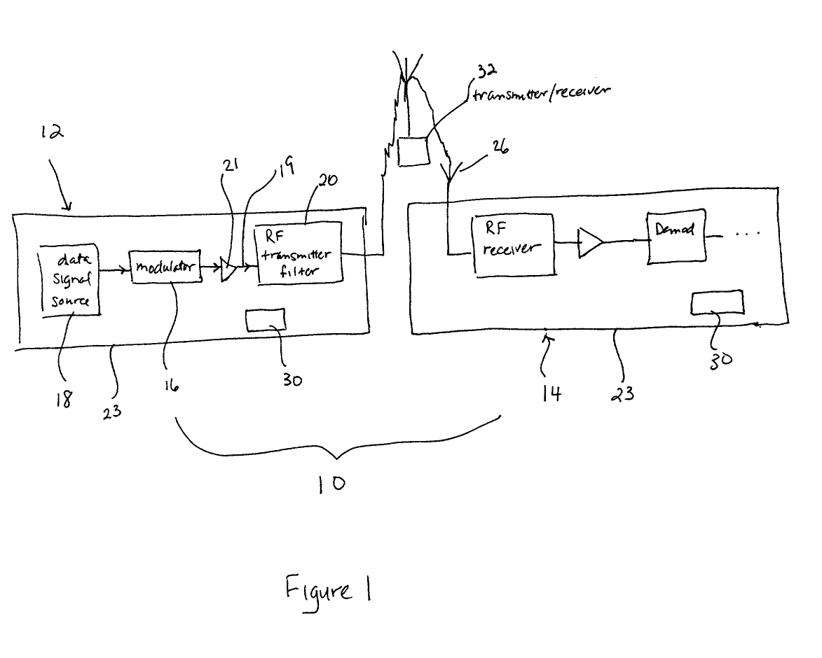

A generalized representation of a communication system environment of an embodiment of the present invention is shown in FIG. 1, wherein a communication system 10 includes a transmitting unit 12 and a receiving unit 14. The transmitting unit 12 includes a modulator 16 connected to receive data signals (baseband) from a data signal source 18 and provide a modulated signal 19. The modulated signal is amplified by an amplifier 21 to a predetermined output power level. The amplified modulated signal is provided to a transmitter filter 20, the output of which is provided for transmission or the communication channel, for example, from an antenna 22. Components of the transmitting unit, such as the transmitter amplifier 21, are powered by a power source 30.

The receiving unit 14 includes a receiver filter 24 connected to an antenna 26, to receive a modulated signal. The filter 24 provides a corresponding modulated signal 27 to an amplifier 21 and a demodulator 28, for demodulation to produce the data signal (baseband). The demodulated signal may be provided to signal processing electronics, sound producing electronics or the like, depending upon the nature of use of the communication system. Components of the receiving unit are also powered by a power source 30. The transmitter 12 and receiver 14 units include further components well known in the art for effecting transmission and reception of signals and for carrying out other functions specific to the application of use of the system.

In preferred two-way communication system embodiments, such as cellular telephone embodiments or cordless telephone embodiments, each unit 12 and 14 is configured to function as both a transmitting unit and a receiving unit. In one system embodiment, the units 12 and 14 transmit and receive signals directly therebetween. In other system embodiments, the units 12 and 14 communicate through one or more additional transmitter/receiver configurations (such as repeater, base or cell stations), generally represented as reference character 32 in FIG. 1.

Preferred embodiments of the present invention relate to a communications system 10 wherein the transmitting (or transmitting/receiving) unit 12 utilizes a limited power supply. Preferred embodiments of the communications system 10 employ an apparatus and method for monitoring the capacity of the power supply and modulating the output power level of the transmitter amplifier 21, based on the remaining power supply capacity, utilized during a given transmission.

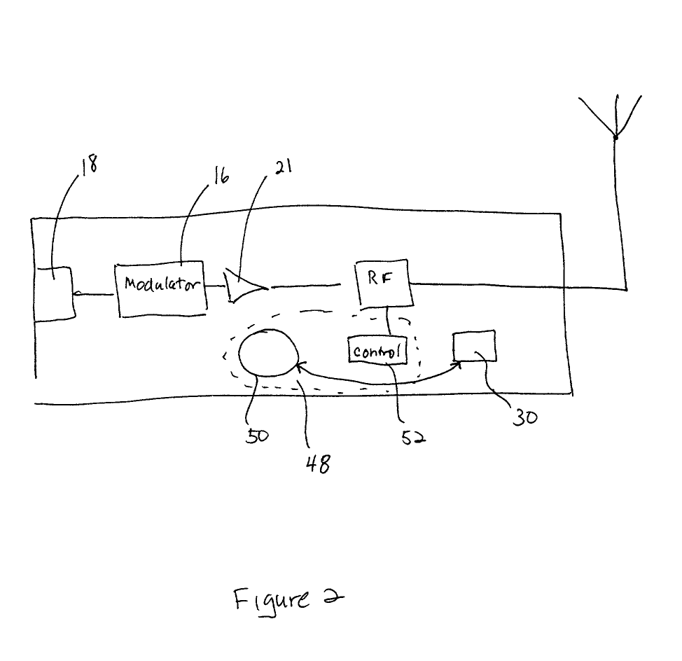

With reference to FIG. 2, preferred embodiments of the instant invention include a monitoring system 48 for monitoring the power capacity of the power supply 30 and modulating the output power level of the amplifier 21 in response thereto. The monitoring system 48 is disposed within the housing 23 of the transmitting unit 12 and comprises a sensor 50 and a processor 52.

The sensor 50 is coupled in electronic communication with the power supply 30 and the processor 52. The sensor 50 may be any suitable device capable of detecting the output level of the power supply 30 and communicating with the processor 52. For example, the sensor 50 may comprise a voltage sensor or, alternatively, a current sensor, or any other capacity gauging mechanisms for evaluating the remaining capacity stored in the power supply 30. Typically, as the power capacity of a limited power supply depletes (such as from usage over a period of time), the output voltage level decreases, requiring a corresponding increase in the output current level to maintain a given overall power output (according to the equation P=V*I, where P is the output power, I is the output current level and V is the output voltage level).

In one embodiment, the sensor 50 comprises a voltage sensor coupled to monitor the output voltage of the power supply 30 to determine whether the power level has dropped to or passes below a predetermined threshold voltage level. The sensor 50 measures the voltage level of the power signal drawn by the amplifier 21 during data transmission, wherein a given quantity of power supply power is required to perform the transmission function, dependent upon the transmission power requirements. In some preferred embodiments, the sensor 50 continuously monitors the power supply power. In still other preferred embodiments, the sensor 50 is controlled, such as, for example, by the processor, to monitor the power supply power periodically. If the voltage level has dropped to, or below, the predetermined threshold level, the sensor 50 provides the processor 52 with a signal indicative of that event.

In another preferred embodiment, the sensor 50 comprises a current sensor coupled to monitor the output current level of the power supply signal drawn by the amplifier 21 during transmission. If the current level increases to or passes above a predetermined current level threshold, the sensor 50 provides the processor 52 with a signal indicative of that event. The processor 52 is in electronic communication with the amplifier 21 and is coupled to control the required output power level of the amplifier 21, for example, in accordance with well-known processor-controlled amplifier technology. In preferred embodiments, a processing chip, such as, for example, M46, manufactured by Rockwell, Newport Beach, Calif., is used, although any processor capable of communicating with, and controlling, the amplifier 21 as described herein may be suitable.

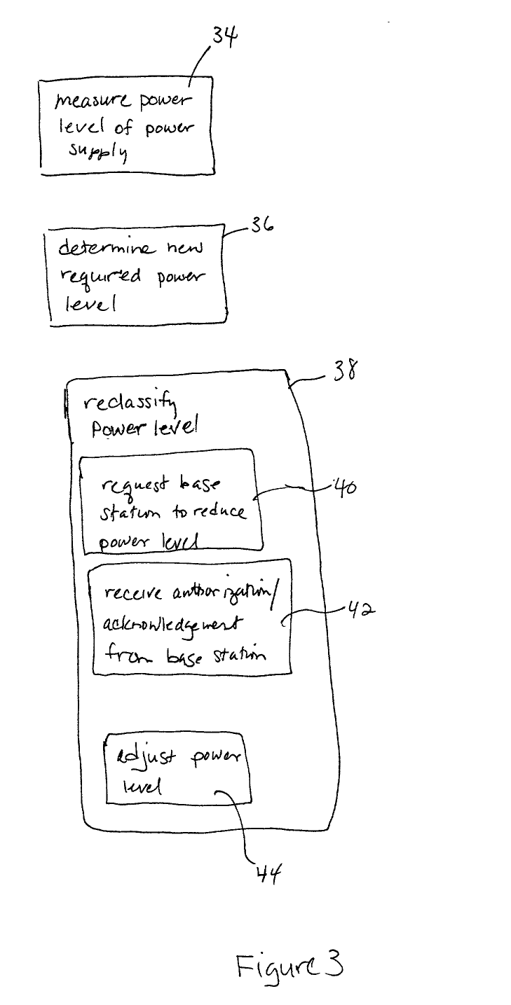

The sensor 50 and the processor 52 cooperate to monitor and adjust the required output power level of the amplifier 21 such that the rate of power usage and, thus, diminution of a limited power supply 30 is reduced, to extend the duration of time that the power supply 30 can operate the transmitting unit. With reference to FIG. 3, preferred embodiments of a method for monitoring the power supply 30 and modulating the required output power level of the amplifier 21 comprise measuring the output level of the power supply 34, determining an output power level for the amplifier 36 dependent upon the measured output level of the power supply 34 and reclassifying the output power level 38.

For example, a transmitter in a communication system according to preferred embodiments of the present invention is controlled to provide a transmission signal at predefined transmission power level determined by the output power level of the amplifier 21. Generally, the amplifier 21 draws power from the battery 30, wherein the rate of power drawn is determined by the output power required of the amplifier 21 to provide the predefined transmission power level. As the battery voltage depletes, the amplifier 21 requires more current to maintain the desired level of output power. Thus, the amplifier 21 draws greater amounts of current from the battery 30, which results in yet a greater depletion of the remaining power available in the battery 30. In view of this relationship, a threshold level may be selected, beyond which the maintenance of the amplifier 21 at the currently required output power level depletes the power level of the battery at an undesired rate.

In preferred embodiments, when the threshold level is reached (or passed), the rate of depletion of the battery's power supply is reduced by the output power of the amplifier 21 to a lower output power level. By lowering the level of the amplifier output power, the amount of current drawn from the battery 30 will also be reduced. Thus, in preferred embodiments, when the power supply output level reaches or passes a predetermined threshold, the amplifier output power is lowered, to result in a reduced rate of current drawn by the amplifier and, thus a reduced rate of depletion of the power source. In a further preferred embodiment, a second threshold valve is then used for the lower amplifier output power level.

In preferred embodiments, the amplifier output power level is determined by a preset reduction schedule. In preferred embodiments, the reduction schedule includes a series of power range levels that represent consecutive ranges of power. For instance, in one preferred embodiment, the schedule includes levels A-C, wherein level A is between 10-20 W; level B is between 21-30 W; and level C is between 31-60 W. The new output power level is generally set as the level immediately below the currently set power level. Thus, for example, for a transmitter operating at level C, the new output power level is set at level B upon the sensor detecting a power supply output level at or passing a threshold.

In other preferred embodiments, the reduction schedule is determined by a variety of methods, including, but not limited to, reduction by a specific amount. For instance, in one preferred embodiment, the power requirement is reduced by 3 dB regardless of the current power requirement upon the sensor detecting a power supply output level at or passing a threshold. In this embodiment, the reduction has little affect on the range of the transmitting unit 12 as there is effectively a more significant change in the amount of power that is being transmitted for each 3 dB of power reduction.

In another preferred embodiment, the output power level is reduced between a range of amounts, such as, for example, between 20-50 W. In still another preferred embodiment, the output power level is reduced to a predetermined specified amount respective of the current output power. For instance, in one preferred embodiment, the output power is reduced to 35 W regardless of the initial power level. In still other preferred embodiments, a series of power values, for purposes of reduction, are preset. For instance, in one embodiment, in instances wherein multiple reductions of output power levels are required, the power is reduced, for example, as follows: initial power level to 50 W; 50 W to 35 W; 35 W to 15 W; and 15 W to 10 W. Further, in some preferred embodiments, factors such as, for example, the type of battery determines the amount of the reduction of power.

Once a determination is made as to the power reduction 36, the output power level is reclassified 38. Reclassification of the output power level 38 includes requesting the permission to the base station to reduce the output power level 40, receiving authorization or acknowledgment from the base station 42 and adjusting the output power level 44.

Prior to reducing the output power level, the transmitter submits a request to the base station to reduce the output power level 40. In response, the base station authorizes and acknowledges the request 42 from the transmitter. This authorization procedure is well known in the art and thus, not described in further detail herein. After the base station authorizes the change in the power level 42, the processor provides a control signal to adjust or change the output power level 44 of the amplifier 21.

The operation of an embodiment of the instant invention is described below with respect to a system including cellular telephones that communicate with each other through a base station. This is meant as illustrative only and is not intended to limit the invention. Further, the operation is applicable to both the transmitting and receiving cellular telephone; however, for ease of description, reference is only made to a transmitting cellular telephone.

In operation, prior to any transmission or receipt of data signals the transmitting cellular telephones sends a signal to a base station and establishes communication. Establishment of communication includes determining the appropriate output power level of the transmitting unit based upon the distance of the unit from the base station. Once the output power level is established and set in the transmitting unit, a transmission, or a telephone call, can be made or can proceed.

Transmission of the voice or data signals (or a carrier signal modulated with voice or data information) is performed at the predefined output power level. To achieve the output power level, the amplifier draws current from the battery sufficient to output the signals at the desired output power level. During transmission or after the signals have been transmitted, the sensor in the power monitoring system measures the voltage (or current) output of the battery drawn by the amplifier. If the voltage (or current) level output of the battery has dropped (or increased) to, or below (or above), a predetermined threshold value, the sensor provides the processor with a signal representing that event.

In response, the processor determines the next appropriate output power level. As discussed above, various appropriate methods exist for determining the appropriate output power level. Assuming a scheduled reduction, the processor determines the output power level that is one below the current output power level. After establishing the new desired output power level, the transmitter 12 communicates a request to the base station, which in turn, responds with authorization. Upon receiving authorization from the base station, the transmitter adjusts the output power level by resetting the amplifier 21 to provide a lower amplifier output power level and, thus, draw a reduced amount of current from the battery 30.

The foregoing description of preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. In a communication system having a power supply for supplying an output power signal to a controllable amplifier for amplifying a signal for transmission on a communication channel at a transmission power level dependent upon the level of the output power signal, a method for controlling the transmission power comprising:
detecting the output power level of the power supply;
comparing the detected output power level with a threshold level; and
controlling the amplifier to amplify the signal for transmission by an amplification factor dependent upon the compared output and threshold levels.

2. A method as claimed in claim 1, wherein detecting the output level comprises detecting the current level from the power supply.

3 A method as claimed in claim 1, wherein detecting the output level comprises detecting the voltage level from the power supply.

4. A method as claimed in claim 2, wherein comparing the detected output level comprises detecting an increase in the current level at, or passing, a threshold value.

5. A method as claimed in claim 3, wherein comparing the detected output level comprises detecting an decrease in the voltage level at, or passing, a threshold value.

6. A method as claimed in claim 4, wherein controlling the amplifier comprises controlling the power amplifier to reduce the amplification factor.

7. A method as claimed in claim 5, wherein controlling the amplifier comprises controlling the power amplifier to reduce the amplification factor.

8. A communications system having a limited power supply, wherein the amount of available power in the power supply is determined by a power level, comprising:
a transmitting unit capable of transmitting data signals to a defined destination, wherein the transmitting unit further comprises:
a power monitoring system, including a sensor capable of monitoring the power level of the power supply, and a processor capable of adjusting the output power level of the transmitting unit.

9. An apparatus as claimed in claim 8, wherein the transmitting unit is configured to receive incoming data signals.

10. An apparatus as claimed in claim 8, wherein the processor is capable of reducing the output power level of the transmitter.

11. An apparatus of claim 8, wherein the transmitter further comprises an amplifier and wherein the power supply comprises a battery that is in electronic communication with the amplifier.
